(19) United States
(12) Patent Application Publication
(10) Pub. No.: US 2008/0064796 A1
(43) Pub. Date: Mar. 13, 2008

(54) Articles formed of phosphorous containing reprocessed polymer materials

(75) Inventors: Philip D. Bourgeois, Red Lion, PA (US); Sami Al-AbdulRazzak, Mississauga (CA)

Correspondence Address: RISSMAN JOBSE HENDRICKS & OLIVERIO, LLP, 100 Cambridge Street, Suite 2101, BOSTON, MA, 02114, US

(73) Assignee: Graham Packaging Company, LP, York, PA (US)

(21) Appl. No.: 11/518,669

(22) Filed: Sep. 11, 2006

(51) Int. Cl. C08K 5/49

(52) U.S. Cl. 524/115; 524/604

(57) ABSTRACT

Polymer materials that have been previously melt formed and cooled, can be reused in subsequent melt processes without undue degradation in one or more aesthetic or functional properties. The addition of phosphorous facilitates the reuse of the previously melt formed and cooled mixture of polymer material, e.g., commingled post consumer regrind and/or commingled plant scrap regrind. The processed mixture can then be reused in a significantly higher amount (than is possible without the phosphorous material) in a subsequently melt formed article without producing an undesirable amount of, for example yellowing, haze and/or reduction in melt viscosity. The reprocessed material may further provide increased layer compatibility in a subsequently formed multilayer article.

### FIELD OF THE INVENTION

The present invention relates to the treatment and use of polymer materials processed under elevated temperature and pressure in various molding (e.g., injection, extrusion) processes. In particular the invention relates to the treatment of polymer materials that have been previously melt formed and cooled, enabling their reuse in subsequent melt processes without undue degradation in one or more aesthetic or functional properties.

### BACKGROUND OF THE INVENTION

Injection and extrusion molding are well known methods for manufacturing plastic articles known as preforms which may subsequently be expanded (e.g. blow molded) into bottles or other containers. In particular, it is desirable to produce clear and transparent articles from such materials.

When plastic materials are subjected to elevated temperatures and pressures as are typically used in the referenced molding processes, the plastic materials can be prone to molecular degradation, unwanted polymerization and unwanted reaction with other materials that may be present in the plastic material. This is particularly true in polymer materials that have been processed once and are processed a second time at elevated temperature, i.e., subjected to a second melting and processing cycle as is typical in reusing scrap or recycled plastic preforms or bottles as the raw plastic material for new preforms and bottles. Such polymer reaction processes can cause the plastic material to acquire undesirable coloring, yellowing, blackening, haze or other degradation of transparency. Such processes may also cause a reduction in melt strength, intrinsic viscosity (IV) or otherwise deleteriously effect their processability or layer compatibility during subsequent molding into a shaped article, or the physical or aesthetic properties of such article during use.

### SUMMARY OF THE INVENTION

In accordance with various embodiments of the invention, there are provided phosphorous containing reprocessed polymer materials, articles formed thereof, and methods of forming such articles. It has been found that the addition of phosphorous facilitates the reuse of a previously melt formed and cooled mixture of polymer materials, namely a mixture of two or more different polymers that have previously been (separately or together) melt formed and cooled (hereinafter “processed mixture”), such that the processed mixture can be reused in forming an article in a subsequent melt process with a reduced tendency to produce one or more of an undesirable coloring (e.g., yellowing), haze or other degradation of transparency, and/or a reduction in melt viscosity. The addition of phosphorous thus enables or enhances the reuse of such processed mixture in a subsequent melt formed article.

In one embodiment, the phosphorous material is a phosphite and is added to the processed mixture (e.g., commingled post consumer regrind or commingled plant scrap regrind), thus enabling the processed mixture to be reused in a significantly higher amount (than is possible without the phosphorous material) in a subsequently melt formed article without producing an undesirable amount of yellowing, haze and/or reduction in melt viscosity. The subsequently formed article may comprise all or a portion of a monolithic or a multilayer article, wherein the formed article is preferably substantially clear and transparent, and/or exhibits improved delamination resistance or layer compatibility. Other materials, polymer and/or non-polymer, which may or may not have been previously melt formed and cooled, may be present in the melt in addition to the reprocessed mixture and included in the subsequently melt formed article.

In one example, the processed mixture may comprise as its principal component an ester containing polymer, such as an aromatic polyester, and more specifically polyethylene terephthalate (PET). It may further comprise a polyamide material such as, for example, a meta-xylylene polyamide such as MXD6, and optionally a transition metal (e.g., cobalt) in an amount which provides active gas barrier performance. This processed mixture of polymer materials that have previously been subjected to a melt process (i.e., polymer that has previously been melted from a polymer in its solid form at room temperature and then cooled), is then subsequently melt processed in combination with phosphorous and the reprocessed mixture used to form at least a portion of an article. As used herein, an article includes all or a portion of an article, which may take the form of, for example, a package, container, preform, closure, liner, sheet or film. For example, the article may be a multilayer preform including one or more layers of an ester containing polymer, such as PET, and one or more layers of the reprocessed mixture, of which the principal component is PET. The invention enables the use of such reprocessed mixtures in greater amounts and/or applications where such reprocessed mixture, without the addition of phosphorous, would not provide the desired aesthetic and/or functional performance characteristics. Reuse of the processed mixture may thus provide a significant reduction in cost of the subsequently formed article.

In alternative embodiments, the processed mixture may comprise any structural or matrix polymer, typically as a principal (greater than 50% by total weight) component, and one or more barrier materials such a polyalcohol, polyamide, polyolefin, polyalkyldiene, polyglycolic acid (PGA), acrylonitrile copolymer, cyclic olefin copolymer, and copolymers and blends thereof. More specific examples of barrier materials include ethylene vinyl alcohol copolymer (EVOH), nylon, such as nylon-6 or a meta-xylylenediamine (MXD6), polyester/polyolefin copolymers (e.g. a polybutadiene/polyester copolymer in the presence of a transition metal, such as Amosorb®, available from BP p.l.c., London UK), and polyvinylidene chloride (PVDC). Suitable ester containing matrix polymers include polyethylene terephthalate (PET), polybutylene terephthalate (PBT), polypropylene terephthalate (PPT), polyethylene naphthalate (PEN), poly(lactic acid) (a.k.a. polylactide) (PLA), and polytrimethylene naphthalate (PTN). Other suitable matrix polymers include polyacrylates, such as polymethyl methacrylate (PMMA) and polyethylene methacrylate (PEMA), polyolefins, polyamides, and polycarbonate. The matrix polymer is preferably an aromatic polyester, such as PET. The gas barrier material and/or the structural polymer material may further include a layer adhesion promoting material, e.g., an amine polymer, such as polyethyleneimine (PEI) polymer. Alternatively, a layer adhesion promoting additive is not required.

In various applications, phosphorous is added (to the reprocess melt) in an amount sufficient to substantially prevent or reduce the amount of yellowing, reduction in melt strength, formation of haze, or other loss of thermal stability of the processed mixture when subsequently used in a melt process to form an article. In various embodiments, plant scrap and/or previously used articles are ground (e.g., into flake) and the reground material can either be compounded (e.g., melt extruded and pelletized) with the addition of the phosphorous material, or provided as regrind flake and together with the phosphorous material processed directly by addition/mixing of the phosphorous material via the feed throat of the injection molding machine. Yet another approach is production of a masterbatch concentrate material, such as a pellet formed with a high concentration of phosphorous material, that is later blended/mixed with the processed mixture. The processed mixture may optionally be crystallized and dried for ease of processing. Still further, some or all of the phosphorous may be provided in the polymer material(s) prior to, during or after the previous melt forming and cooling. For example, some or all of the phosphorous may be incorporated in the material used to make the prior melt formed and cooled article, in anticipation of the article being reprocessed as a blended material (and thus at a higher level than may be present for the melt forming of virgin polymer).

In various embodiments, the phosphorous material comprises a phosphorous atom bound to one or more oxygen atoms. The one or more oxygen atoms may be bound to an organic substituent, which organic substituent may include an aromatic moiety. Two or more aromatic moieties may be bound to the phosphorous atom. The phosphorous material may comprise one or more of a phosphite, a phosphonite and a phosphate. In one embodiment, the phosphorous material is a phosphite material having one or more oxygen atoms bound to an organic substituent, wherein the organic substituent may include an aromatic moiety.

In one embodiment, an article is formed from a melt mixture, the melt mixture including a reprocessed mixture of polymer materials that have been previously melt formed and cooled, and a phosphorous material present in an amount sufficient to enhance a desired aesthetic and/or functional property of the reprocessed mixture in the article.

In the article, the phosphorous material may comprise one or more of a phosphite, a phosphonite, and a phosphate. Preferably, the phosphorous material comprises a phosphite material.

The reprocessed mixture may include a structural polymer and a gas barrier polymer. The structural polymer may comprise one or more of polyester, polyolefin, polyamide, polyacrylate, poly(lactic acid), polycarbonate, and copolymers and blends thereof. The gas barrier polymer may comprise one or more of polyalcohol, polyamide, polyglycolic acid, acrylonitrile copolymer, cyclic olefin copolymer, polyvinylidiene chloride, and copolymers and blends thereof.

In one embodiment, the reprocessed mixture includes:
an ester containing polymer and a gas barrier polymer;
the ester containing polymer comprising one or more of polyethylene terephthalate (PET), polyethylene naphthalate (PEN), polypropylene terephthalate (PPT), poly(lactic acid) (PLA), polytrimethylene naphthalate (PTN), and copolymers and blends thereof; and
the gas barrier polymer comprising one or more of polyalcohol, polyamide, polyglycolic acid (PGA), acrylonitrile copolymer, cyclic olefin copolymer, polybutadiene/polyester copolymer, polyvinylidiene chloride, and copolymers and blends thereof.

The article may be one or more of a package, container, preform, closure, liner, sheet or film. The article may be a multilayer article that includes one or more layers of the reprocessed mixture. The article may be a substantially transparent and/or clear article.

The reprocessed mixture may comprise an ester containing polymer and a gas barrier polymer, and the article may comprise a multilayer article including at least one layer of the reprocessed mixture and an adjacent article of an ester containing polymer. The ester containing polymer may be an aromatic polyester and the gas barrier polymer may be a nylon including meta-xylylene groups.

The reprocessed mixture may include polyethyleneimine (PEI). The reprocessed mixture may include polyethylene vinyl alcohol copolymer (EVOH) and PEI.

The reprocessed mixture may comprise regrind.

In various embodiments, the phosphorous material is present in the melt mixture in an amount sufficient to:
reduce or eliminate coloring in the reprocessed mixture in the article;
reduce or eliminate yellowing of the reprocessed mixture in the article;
reduce or eliminate haze in the reprocessed mixture in the article;
thermally stabilize the reprocessed mixture.

The reprocessed mixture may include a structural polymer and a gas barrier polymer, and the reprocessed mixture may form at least one layer of a multilayer article adjacent to another layer of the structural polymer.

The reprocessed mixture in the article may be clear and transparent.

These and other advantages of several embodiments of the invention may be better understood by referring to the following detailed description in conduction with the accompanying drawings.

### BRIEF DESCRIPTION OF THE DRAWINGS

FIG. 1A is a schematic view of a multilayer preform which includes reprocessed polymer material according to one embodiment of the present invention, and FIG. 1B is an expanded partial cross-sectional view of a multilayer sidewall of the preform;

FIG. 2A is a schematic view of a blow molded container made from the preform of FIG. 1A, and FIG. 2B is an enlarged partial cross-sectional view of a multilayer sidewall of the container;

FIG. 3 is a flow chart illustrating alternative method embodiments for producing an article having a layer of reprocessed polymer material according to the present invention;

FIGS. 4A-4D are a series of sequential schematic illustrations of a method for injection molding a multilayer preform, which includes the reprocessed material of the present invention;

FIG. 5A is a graph of “b” value versus thickness (mm), comparing a degree of yellow color in plaques made from various reprocessed polymer materials;

FIG. 5B is a graph of “b” value versus elemental phosphorous weight percent, comparing two different phosphorous additives;

FIG. 6 shows the melt rheology, a plot of shear viscosity (Pa·s) versus corrected shear rate (s⁻¹), for various reprocessed polymer materials to illustrate the effect of phosphorous on melt viscosity;

FIG. 7 is a schematic illustration of another embodiment of a multilayer preform; and

FIG. 8 is a chart of haze measurements on plaques made of various reprocessed polymer materials.

### DETAILED DESCRIPTION

It has been found that adding a phosphorous material to a mixture of previously melt processed polymer materials, herein the processed mixture, enables the processed mixture to be reused in a subsequent melt process without suffering an undue degradation in one or more aesthetic or functional properties of the processed mixture either during the subsequent melt processing or in a subsequently formed article. The phosphorous containing reprocessed mixture may provide one or more of improved transparency, melt strength, lack of or reduced color and/or layer compatibility in the article formed. Various aspects of the invention, as described in the embodiments described below, may be used independently and/or in various combinations to provide compositions, methods and articles in accordance with the invention.

### Processed Mixture of Polymer Materials

A processed mixture of polymer materials includes two or more polymers having different chemical structures. For example, an aromatic polyester (e.g., PET or PEN) and a polyamide (e.g., nylon). Another example of different polymers would be an aromatic polyester and an aliphatic polyester (e.g., PGA). Another example is PET and EVOH. Yet another example is PET and a polybutadiene/polyester based copolymer.

Polymer material that has been melt formed and cooled as used herein refers to a polymer material that has been previously melted from a polymer in its solid form at room temperature, formed (e.g., into a three-dimensional object or sheet) and then cooled into a formed article.

The previously melt processed and cooled polymer materials are typically cleaned/washed, ground up into a bulk flake, or extruded and formed into pellets or other readily transportable form and then used in a new, subsequent forming cycle, such as injection molding, where a mixture including such polymer material is subjected to a new, subsequent heat treatment that melts the polymer materials.

The starting (previously melt processed and cooled) polymer materials may or may not have previously been mixed with substantial amounts of other polymer or non-polymer materials, which other materials may or may not have been subjected to previous melt processing. The starting polymer material may come from previously formed articles, such as preforms, bottles, containers and the like, or manufacturing scrap from making such articles, and may contain one or more inorganic atoms (such as cobalt, magnesium, iron, chromium, copper and the like) that were added to the polymer material for other purposes, such as oxygen scavenging or reduced gas permeability and the like.

The starting polymer material may come from a monolithic article or from one or more layers of a multilayer article, and may include: a structural polymer material such as polyethylene terephthalate (PET), polyethylene naphthalate, polycarbonate, poly(lactic acid) (PLA), polystyrene, a polyacrylate (e.g. polymethyl or polyethyl methacrylate), polypropylene, polyethylene; and one or more layers of another polymer material used as a functional layer, e.g., oxygen or gas barrier or scavenging polymer layer containing polyamide (e.g., nylon or meta-xylylenediamine (MXD)), polybutadiene/polyester based copolymers (e.g., Amosorb®), EVOH or other material, which may optionally contain a transition metal (e.g. cobalt).

A “barrier material” as used herein is any material that exhibits a reduced rate of permeation for a particular substance, such as oxygen or carbon dioxide, in comparison to another material. A “passive barrier material” is generally understood to reduce the rate of permeation by blocking passage of the particular substance, e.g., oxygen or carbon dioxide. An “active barrier material” is commonly understood to refer to a material having the ability to consume a particular substance through chemical and/or physical means. In the context of a closed environment with the active barrier material present, the consumption of for example molecular oxygen may eliminate or substantially reduce the net ingress of oxygen into the closed environment. Moreover, the consumption of molecular oxygen may reduce the total enclosed amount of molecular oxygen.

Polymer material as used herein means a homopolymer but also copolymers thereof, including random copolymers, block copolymers, graft copolymers, etc. A polymer material may be of a single polymer or a mixture or blend of multiple polymers; it may further include nonpolymer materials added for any of various processing, performance or aesthetic characteristics.

### Aesthetic or Functional Property

Aesthetic or functional property of a polymer material as used herein refers to any of various physical properties (e.g., tensile strength, impact resistance, tear strength), thermal properties (e.g., melt strength, rate of crystallization) and/or aesthetic properties (e.g., transparency, color, gloss).

Transparent as used herein refers to a polymer material that is substantially transparent such that the amount of haze (opacity) is not significantly detectable by unaided human vision. A suitable measure of transparency is the percent haze for transmitted light through the wall (H_{T}) which is given by the formula:

H_{T}=[Y_{d}÷(Y_{d}+Yₛ)]×100

where Y_{d} is the diffuse light transmitted by the specimen, and Yₛ is the specular light transmitted by the specimen. The diffuse and specular light transmission values are measured in accordance with ASTM Method D 1003, using any standard color difference meter such as the UltraScan XE manufactured by HunterLab Inc. (www.HunterLab.com). Preferably, a substantially transparent article, such as a beverage container, would have a percent haze through the sidewall of less than about 15%, and more preferably less than about 10%.

Clear as used herein refers to a polymer material that is substantially lacking in color (e.g., yellow) such that the amount of color is not sufficiently detectable by unaided human vision. Preferably, the phosphorous material is added to the processed polymer materials in an amount sufficient to reduce the standard HunterLab yellow “b value” of the material to less than about 5 as measured in a plaque having a thickness of between about 0.5 and about 3.0 mm. A convention for measurement of such “b values” is described in HunterLab application Note, Insight on Color, Vol. 8, No. 9, pp. 1-4 (Aug. 1-15, 1996), (available at www.HunterLab.com).

### Phosphorous Material

One or more phosphorous containing materials having the following formula can be used as an additive to the starting polymer material (e.g., regrind) according to various embodiments of the invention: P—(O—R)₃ or R₁—P—(O—R)₂ or P—(O—R)₄ or R₁—P—(O—R)₃ or (R₁)₂—P—(O—R)₂, where R and R₁ are H or an organic substituent, most preferably containing an aromatic moiety. Specific examples of suitable phosphorous containing compounds are:

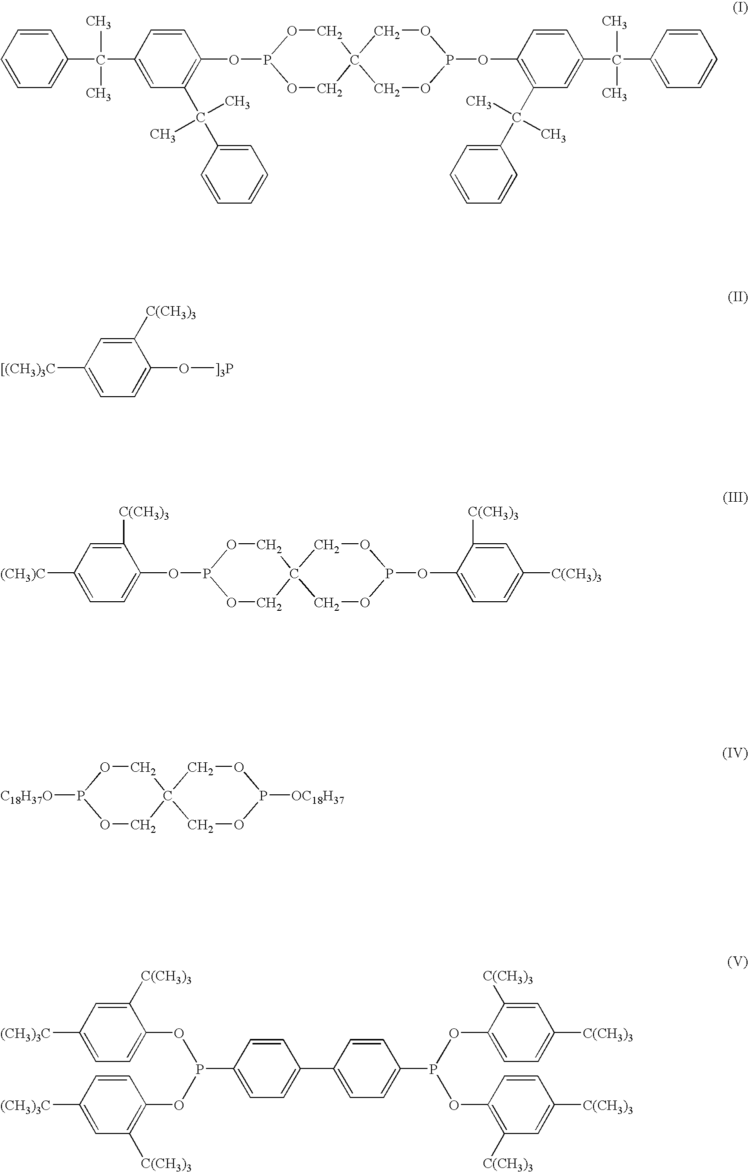

In select embodiments, the phosphorous is added an amount sufficient to reduce or eliminate discoloration. However, in other embodiments the phosphorous is added in an amount sufficient to reduce or eliminate the formation of haze, to reduce or eliminate a loss of melt viscosity (or other indicator of melt processability), or otherwise thermally stabilize (reduce or avoid one or more of the problems identified in paragraph 3 herein) the previously melt formed and cooled polymer material.

Preferred phosphorous containing materials are those having a phosphorous atom bound to one or more oxygen atoms, one or more of which are in turn bound to an organic substituent, most preferably an organic substituent that contains one or more aromatic moieties. The phosphorous atom is most preferably bound to two or more aromatic moieties either through an oxygen atom or directly. The phosphorous containing material is preferably a phosphite, phosphonite or phosphate, most preferably a phosphite.

The following phosphorous containing compounds are suitable examples:

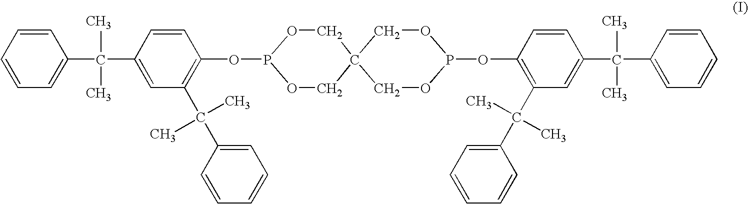

bis(2,4-dicumylphenyl) pentaerythritol diphosphite, CAS Registry No. 154862-43-8, available as Doverphos S-9228 (7.3 weight percent phosphorous) from Dover Chemical Corporation, 3676 Davis Road, N.W., P.O. Box 40, Dover, Ohio 44622-0040, USA;

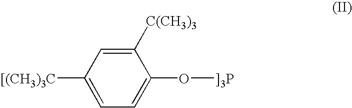

tris(2,4-di-t-butylphenyl) phosphite, available as Doverphos S-480 from Dover Chemical Corp., or as Irgafos 168 (4.8 weight percent phosphorous) from Ciba Specialty Chemicals, Basel, CH;

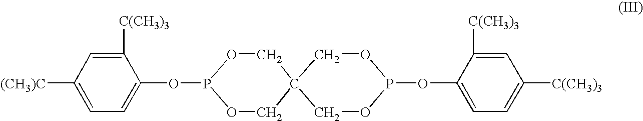

bis(2,4-di-t-butylphenyl) pentaerythritol diphosphite available as Doverphos S-9432 from Dover Chemical Corp.;

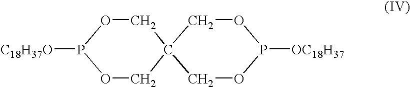

distearyl pentaerythritol diphosphite available as Doverphos S-682 from Dover Chemical Corp.; and

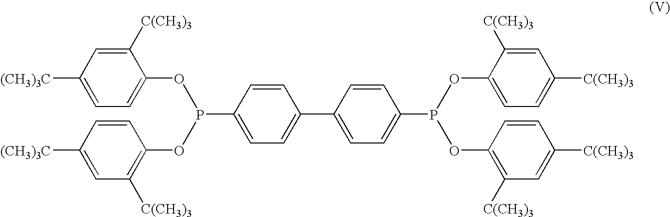

tetrakis(2,4-di-t-butylphenyl) 4,4′-biphenylene diphosphonite available as P-4 from Dover Chemical Corp.

The phosphorous material, when present in the melt of the reprocessed mixture, may (without being bound or limited to this theory) interfere with or reduce degradation between the different polymer materials and/or other materials that are present in the reprocessed mixture. Thus the phosphorous material can prevent or lessen: a darkening, yellowing or other color formation; a reduction in viscosity; and/or a formation of haze in the previously melt processed and cooled polymer materials when subjected to another heat history in a subsequent melt processing (e.g., extrusion or injection molding) process.

Phosphorous is typically added to the processed mixture of polymer materials as a phosphorous containing additive, and the phosphorous containing mixture is then reprocessed (the reprocessed mixture) by melt forming back into subsequently molded articles. Other polymer or nonpolymer materials may be added to the reprocessed mixture, before, during and/or after, the melt forming step. In all embodiments described herein, the amount of elemental phosphorous provided in the reprocessing melt is based on the weight percentage of the processed mixture polymer materials (which have been previously melt formed and cooled, either separately or together).

The phosphorous would most typically be added to the processed mixture after the prior melt forming and cooling. It is however also within the scope of the present invention to provide some or all of the phosphorous desired for use in there processed mixture, in the polymer materials prior to or during the prior melt forming and cooling.

When phosphorous is provided as part of a phosphorous containing additive, the mathematical relationship of the weight percentage elemental phosphorous to the weight of additive can be determined as follows, where the weight of processed mixture is the amount in the reprocessing melt:

$$\% elemental phosphorous = \frac{{ω}_{additive}}{{ω}_{additive} + {ω}_{processedmixture}} \times \% {P}_{additive}$$

ω_{additive}=weight of additive

ω_{processedmixture}=weight of processed mixture

% P_{additive}=% elemental phosphorous content of the additive.

Preferably, the phosphorous containing material is added to the reprocessed mixture in an amount such that the elemental phosphorous content of the mixture is in a range of from about 0.01% to about 0.5% by weight of the processed mixture, and more preferably in a range of from 0.03% to 0.25%. Providing more than the minimum amount of phosphorous required to achieve a desired aesthetic or functional property is contemplated as being within the scope of the present invention.

### Reuse of Processed Mixture

In one embodiment of the invention, the processed mixture comprises a supply of plant scrap or otherwise recycled or previously used preforms and/or bottles of multilayered or blended polymer materials which are collected, cleaned, dried and ground up and provided in pellet or flake form, sometimes referred to herein as “regrind” material. Such multilayered scrap or previously used articles may typically comprise, for example, one or more layers of structural polymer material and one or more layers of a functional polymer material, e.g. passive gas barrier or active gas barrier (scavenging) material. Alternatively they may comprise a mixture, blend or copolymer of such structural and/or functional materials. The weight ratio of structural (the principal component) to other polymer materials in such objects typically ranges from about 60% to about 99% of the structural polymer(s), more typically from about 80% to about 99%. The functional polymer material comprises some or all of the remaining weight percent and may comprise a gas barrier (active or passive) composition, which optionally includes a transition metal such as cobalt, magnesium, iron, chromium, copper and the like.

Preferably, the phosphorous material is mixed with the regrind material (prior to or during melting) and the mixture is melted and cooled to form a monolithic article or one or more layers or portions of an article, such as a preform, bottle, package or other article that packages, contains, houses or encloses for example a food or beverage. It is noted that the U.S. Food and Drug Administration has approved the use of phosphorous materials at weight percentages useful in the present invention. Thus, the phosphorous and regrind mixture can be provided in direct food contact, e.g., as a monolithic article or outer layer made from a blend of MXD6, PET and phosphorous.

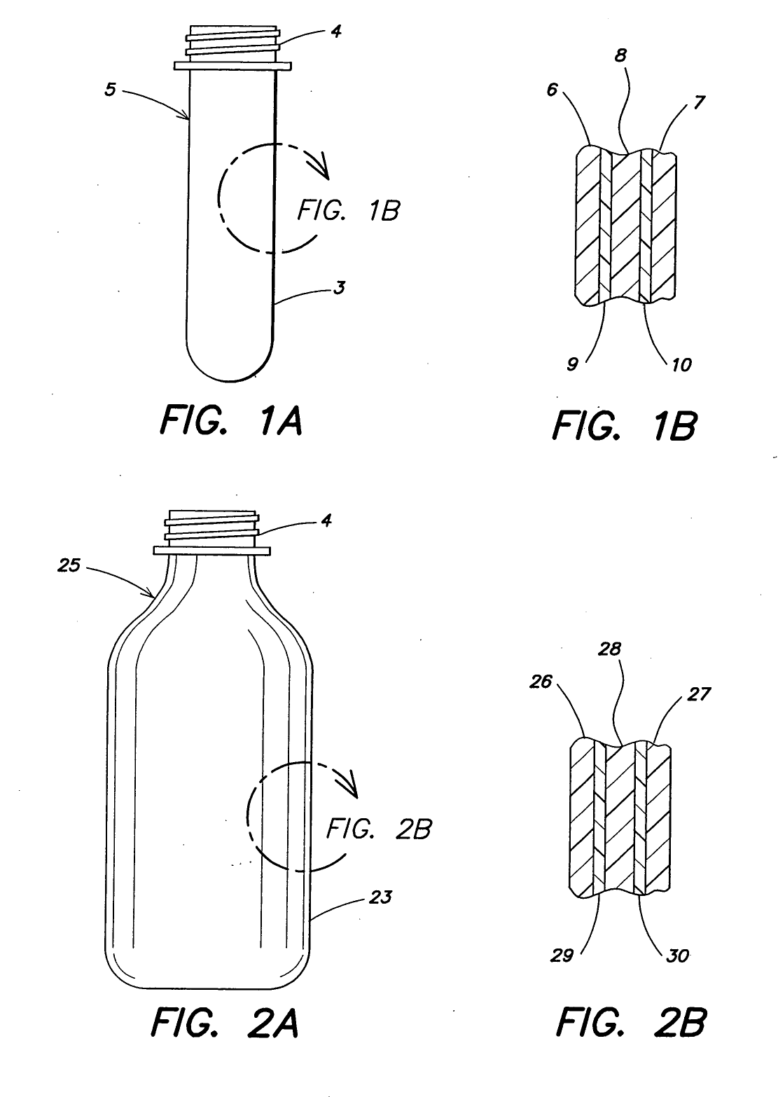

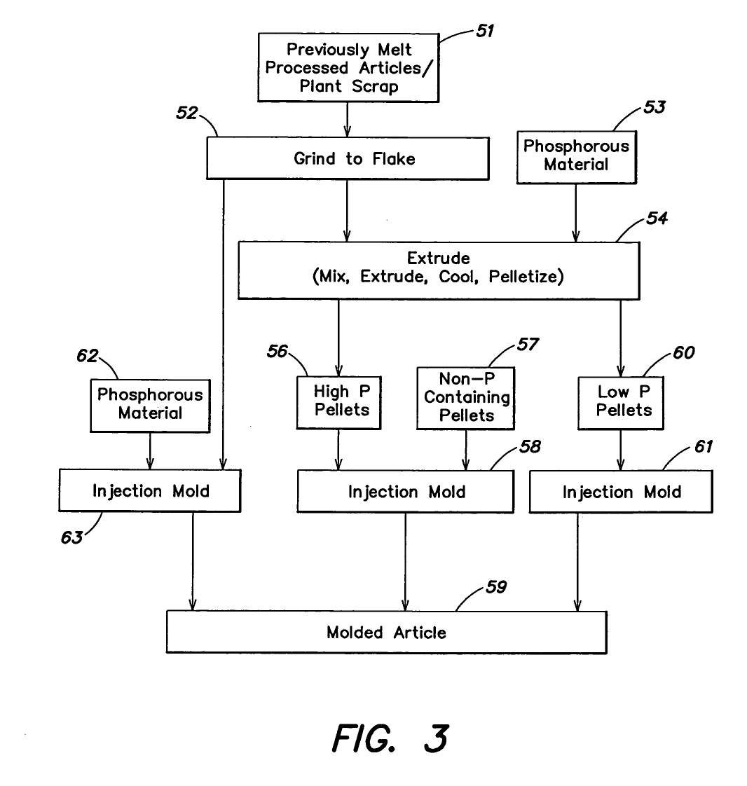

FIG. 1A shows a multilayer preform 5 having a five-layer sidewall, namely exterior inner and outer layers 6 and 7, central core layer 8, and interior intermediate layers 9 and 10 (see the expanded view of FIG. 1B). FIG. 2A shows a container 25 blown from the preform 5 having the same five-layer sidewall with corresponding layers 26-30 (see the expanded view of FIG. 2B). In one such embodiment, the phosphorous containing layer is disposed among the multiple layers of the bottle or package such that the phosphorous containing layer does not make physical contact with the food or drink material that is ultimately packaged or enclosed within the interior space of the bottle, package or article, e.g., provided as an “interior” layer of the multilayered preform (layers 8, 9 and/or 10), bottle (layers 28, 29 and/or 30), package or other object. An interior layer is any layer that is positioned between two other layers of polymer materials.

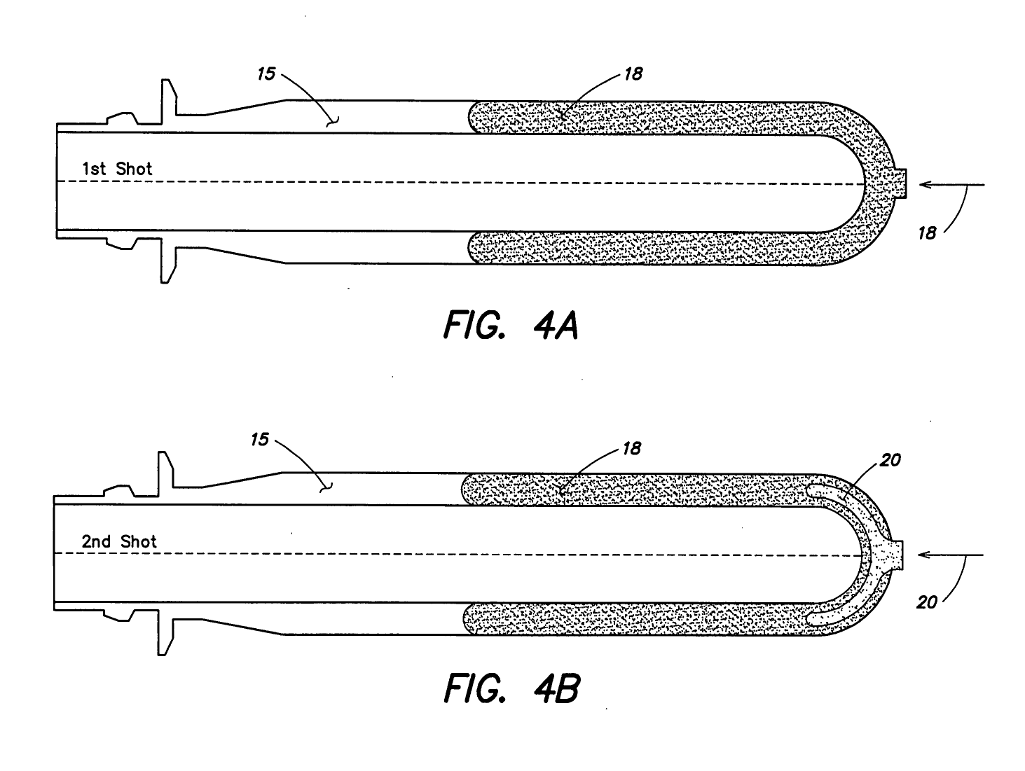

FIG. 3 shows various method embodiments for forming a molded article from the processed mixture. In a first step 51, a collection is made of the previously melt processed articles or scrap. This material is ground into flake in step 52, and subsequently extruded to form pellets in step 54. The extruding step may include mixing, extruding and cooling in order to pelletize the ground flake and make it easier for subsequent handling. Phosphorous material is added to the extruder in accordance with one method embodiment (step 53); alternatively, the phosphorus material and flake may be premixed before introduction to the extruder. The phosphorous material may be provided in a relatively high or a relatively low concentration. In one embodiment, high phosphorous concentration pellets from the extruder are provided in step 56, along with nonphosphorous containing pellets (step 57), to an injection molding machine (step 58) and used to produce a molded article (step 59). In alternative embodiments, low phosphorous concentration pellets (step 60) are added alone to an injection molding machine (step 61) to form a molded article (step 59). In another alternative embodiment, the pelletizing/extrusion step 54 may be eliminated, and instead phosphorous material (step 62) and regrind flake (step 52) are added directly to the injection molding machine (step 63), in order to injection mold an article (step 59).

In a further alternative embodiment, the pellets are first crystallized and dried before being introduced into the injection molding machine. In some cases, amorphous polymer material which is capable of being crystallized is more difficult to process because as it approaches the glass transition temperature it enters a rubber-like or glue-like state which makes it difficult to handle. One solution is to first crystallize the pellets to make them easier to handle during injection molding.

A monolithic or multilayer article may be made which includes the processed mixture according to any of various known melt forming methods, such as injection or extrusion. The article may take any form, such as a sheet, film, closure (e.g., cap) or other shaped article. A multilayer article which includes one or more layers of the phosphorous containing mixture may be made according to any of various known injection or extrusion methods which include sequential, simultaneous and/or combinations thereof. Other materials may be added to the processed mixture and included in the subsequently formed article.

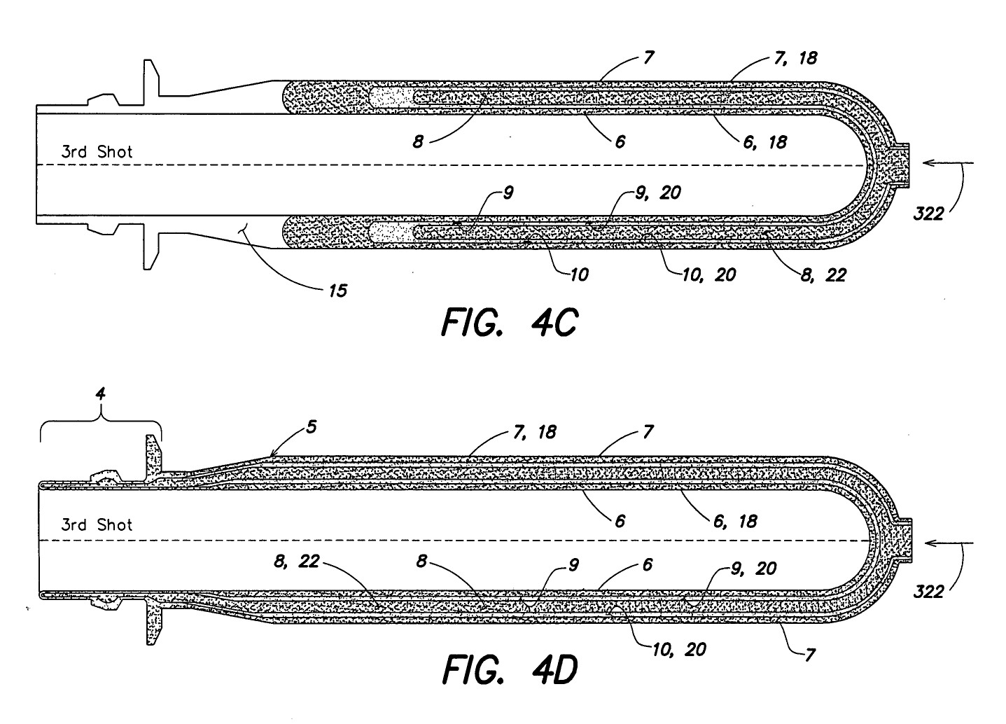

One exemplary multilayer injection molding process, which may be used to form a five-layer preform such as shown in FIG. 1A, is shown schematically in FIGS. 4A-4D. A preform is formed in a mold cavity 15 between an outer mold and core (not shown) of a conventional injection mold. A first shot of first polymer material 18 is injected into the lower end (gate) of the mold cavity and as it flows through the mold cavity, due to the relatively cool temperatures of the outer mold and inner core, there will be solidification of the first polymer material both externally and internally of the mold cavity to define exterior inner and outer layers (layers 6 and 7 in FIG. 1B) of the first material. In FIG. 4A, the relatively large volume of first material has progressed part way (roughly half way) up the mold cavity walls. As shown in FIG. 4B, a second shot of a second polymer material, e.g., a barrier material, is injected into the bottom of the mold cavity. The relatively small amount of barrier material 20 may pool at the lower end of the cavity. A relatively large third shot of a third polymer material 22 is then injected into the gate at a pressure which causes the second shot material 20 to be pushed up the mold cavity and form inner and outer intermediate layers (9, 10 in FIG. 1B) of the preform, while the third material 22 forms a central core layer (layer 8 in FIG. 1B). The tunnel flow of the second and third shots, between the exterior layers 6 and 7, enables the formation of relatively uniform and thin interior layers 9 and 10 of the barrier material 20, and a thicker layer of material 22 in the core layer 8. Finally, the advancing layers reach the end of the mold cavity, producing the five-layer preform structure having interior intermediate and core layers extending up into the neck finish (as shown in FIG. 4D). Alternatively, the interior layers 8, 9 and 10 may extend only partially up the preform wall and terminate, for example, below the preform neck finish 4. This process is described by way of example only, and it not meant to be limiting; many other processes may be used to form multilayer articles, including articles other than preforms. Typical examples of multilayered preforms, bottles and packages, the compositions of the various layers of such multilayer objects, and methods of making such objects are disclosed in U.S. Pat. Nos. 4,781,954; 4,863,046; 5,599,496; and 6,090,460, disclosures of all of the foregoing of which are incorporated herein by reference.

Several more specific embodiments of the invention will now be described for enhancing one or more aesthetic or functional properties of the reprocessed mixture for use in a subsequently melt formed article.

### Enhancing Regrind Color

Plastic containers and preforms comprising multiple polymer materials are now in widespread commercial use for the packaging of food and beverages. For packaging of oxygen-sensitive products, such as juice, ketchup and beer, a polyamide, such as meta-xylylenediamine (MXD) or nylon-6, is often used as an oxygen barrier either alone or in combination with a transition metal; other barrier materials/mixtures include ethylene vinyl alcohol copolymer (EVOH), and copolymers of polyester and polybutadiene in the presence of a transition metal (e.g., Amosorb®).

During commercial production there is typically generated a certain amount of scrap material which would be desirable to reuse. However, the reuse of such materials in large quantities has not been possible due in part to excessive yellowing that occurs when the previously melt processed and formed (e.g., injection molded) material is subjected to a second heat history, i.e., subsequent melting and cooling to form another article. It would be desirable to recycle both scrap material and previously used containers, if not for this problem of excessive yellowing during subsequent melt processing.

In accordance with the present invention, this problem can be solved by incorporating phosphorous material into the polymer reprocessing stream, which eliminates or substantially reduces yellowing and brings the properties of the reprocessed material to values approaching that of virgin polymer material (as supplied by the polymer resin manufacturer with defined thermal and physical properties). The reprocessed polymer material thus treated with the addition of phosphorous can for example be used in a monolithic or one or more layers of a subsequent injection melt processed article alone or as a mixture or blend with other polymers and materials.

In one embodiment, the (previously) processed mixture of polymer materials is plant scrap and/or previously used monolayer blend and/or multilayer containers which include as a principal component an ester containing polymer, a polyamide and optionally a transition metal. In this example, the previously melt processed mixture is a pelletized regrind made from multilayer container and preform articles comprising 97 weight percent by total weight of the article of polyethylene terephthalate (PET), 3 weight percent MXD6, and cobalt added as 0.25 weight percent cobalt neodecanoate based on the weight of the MXD6 (hereinafter the “PET/3% MXD6/Co regrind”). Virgin 8006 PET resin from M&G of Tortona, Italy was used to make the original preforms/containers. The phosphorous material in this example is Doverphos S-9228, comprising bis(2,4-dicumylphenyl) pentaerythritol diphosphite, CAS Registry No. 154862-43-8, having the structural formula:

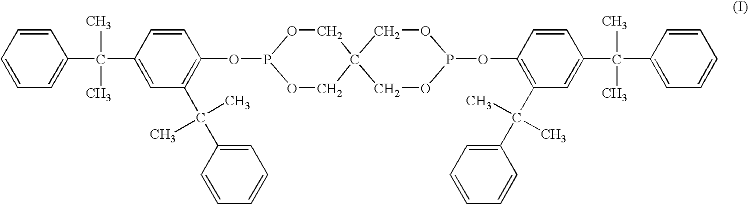

available from Dover Chemical Corporation, 3676 Davis Road, N.W., P.O.B. 40, Dover, Ohio 44622-0040, USA. Phosphorous is added to the PET/3% MXD6/Co regrind and the phosphorous containing regrind is reprocessed (the reprocessed mixture) by melt forming back into subsequently molded articles (e.g., preforms and containers).

In similar embodiments, the original barrier preforms and containers (used to form the regrind) may comprise from up to 15%, and more typically 1% to 2% by weight of one or more barrier polymer(s), and the remaining 80-99% of one or more structural polymer(s). The subsequently formed preform/container may include the reprocessed mixture in one or more layers, with for example 1 to 50 weight percent of the article being of the reprocessed mixture, and more preferably 5 to 40 weight percent. Alternatively the reprocessed mixture is provided in a blend at a weight percent in a range of 10 to 30 of the article weight, more preferably 15 to 25 weight percent.

The phosphorous material is preferably added to the processed mixture (e.g., PET/3% MXD6/Co regrind) in an amount sufficient to reduce the standard HunterLab yellow “b value” of the material to less than about 5 as measured in a plaque having a thickness of between about 0.5 and about 3.0 millimeter (mm). A convention for measurement of such “b values” is described in the HunterLab Color Scale Applications Note of Aug. 1-15, 1996, Vol. 8, No. 9, available from Hunter Associates Laboratory, Inc., 11491 Sunset Hills Road, Reston, Va. 22090, USA.

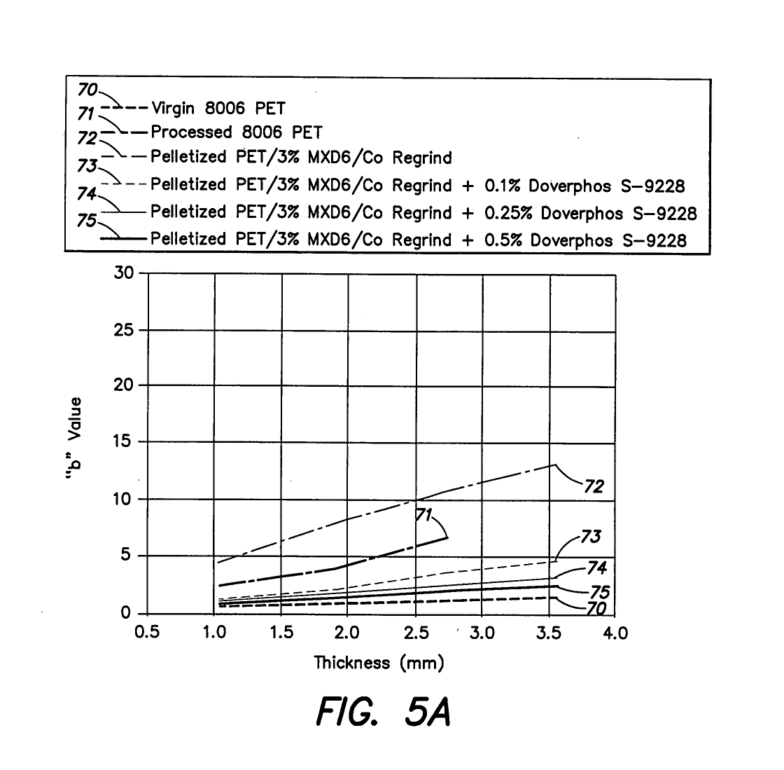

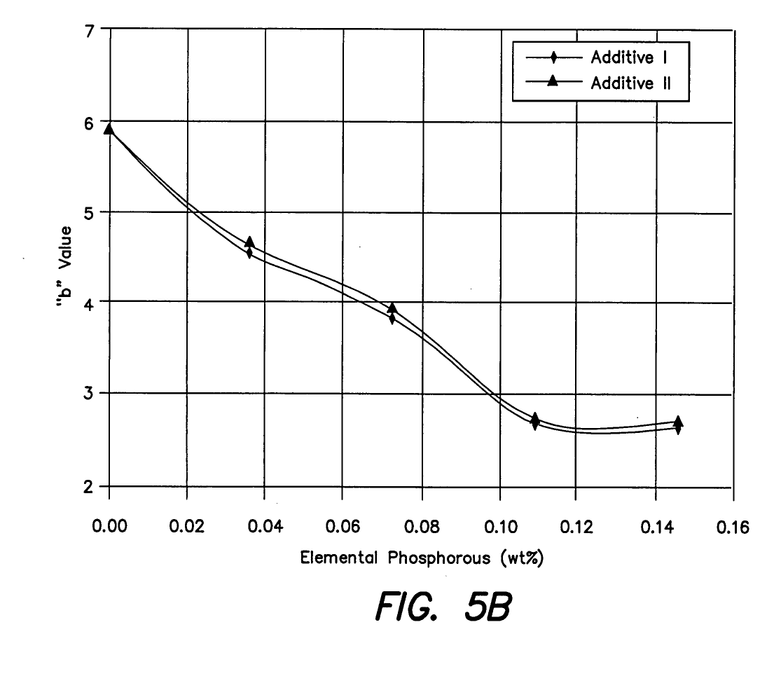

FIG. 5 shows the effect on the b value of varying amounts of phosphorous material, for plaque samples having a thickness ranging from 1 to 3.5 mm. The graph provides a comparison of b values (across the plaque thickness range set forth on the horizontal scale) for:

a) virgin 8006 PET (70);

b) processed 8006 PET (previously melt formed and cooled, before being melt processed (injection molded) to form a plaque) (71);

c) pelletized PET/3% MXD6/Co regrind (previously melt formed articles of PET, 3% MXD6 and 0.25% cobalt neodecanoate as previously described were subjected to two subsequent heat histories, namely a first melt processing comprising twin-screw extrusion and pelletizing and a second melt processing comprising melting of the pellets and injection molding to form a plaque) (72);

d) pelletized PET/3% MXD6/Co regrind (same as c) but with 0.1% Doverphos S-9228 (7.3% P by weight) added as the phosphorous material to the melt during plaque formation (73);

e) pelletized PET/3% MXD6/Co regrind (same as d) but with 0.25% S-9228 (74); and

f pelletized PET/3% MXD6/Co regrind (same as d) but with 0.5% S-9228 (75). As shown in FIG. 5, the virgin 8006 PET (70) has the lowest b value. It would be desirable to attempt to match the b value of the regrind with the low b value of the virgin PET, so that a subsequently formed article of, for example, the virgin 8006 PET and regrind has substantially the same non-yellow (low b value) as would an article processed from virgin 8006 PET. The regrind without phosphorous (72) having been (subsequently) melt processed twice, has the highest b value (least desirable), higher than the processed 8006 PET (71) (subsequently melt processed once). All three samples of regrind (subsequently melt processed twice) with varying amounts of phosphorous (73, 74, 75) have lower values than both the processed 8006 (71), and the regrind without phosphorous (72). Here, the b value improves (approaches that of virgin 8006 PET) with increasing amounts of phosphorous (0.1, 0.25 and 0.5% S-9228).

This example shows that it is possible to reduce or substantially eliminate the undesirable yellowing which occurs during subsequent melt processing of the processed mixture.

FIG. 5B compares the “b” value results for two phosphorous additives compounded into the regrind at different levels and normalized to their elemental phosphorus content. Additive I is Doverphos S-9228 (7.3% P by weight), and Additive II is Irgafos 168 (4.8% P by weight). The regrind is the same PET/3% MXD6/Co regrind previously described. The b value was measured on the actual pellets as compounded, as compared to measuring the b value on plaques molded from the pellets. The regrind was dried to about 50 ppm residual moisture content prior to melt compounding, as is typical in the art. The regrind was formed into pellets utilizing a Coperion ZSK 25 mm co-rotating intermeshing twin screw extruder, made by Coperion Werner & Pfleiderer GmbH & Co KG, Theodorstrasse 10, 70469 Stuttgart, Germany. The melt temperature in the extruder was 280° C. The b value was measured with HunterLab equipment according to the HunterLab process previously described.

FIG. 5B shows substantially similar behavior regardless of the phosphorous source.

### Layer Compatibility

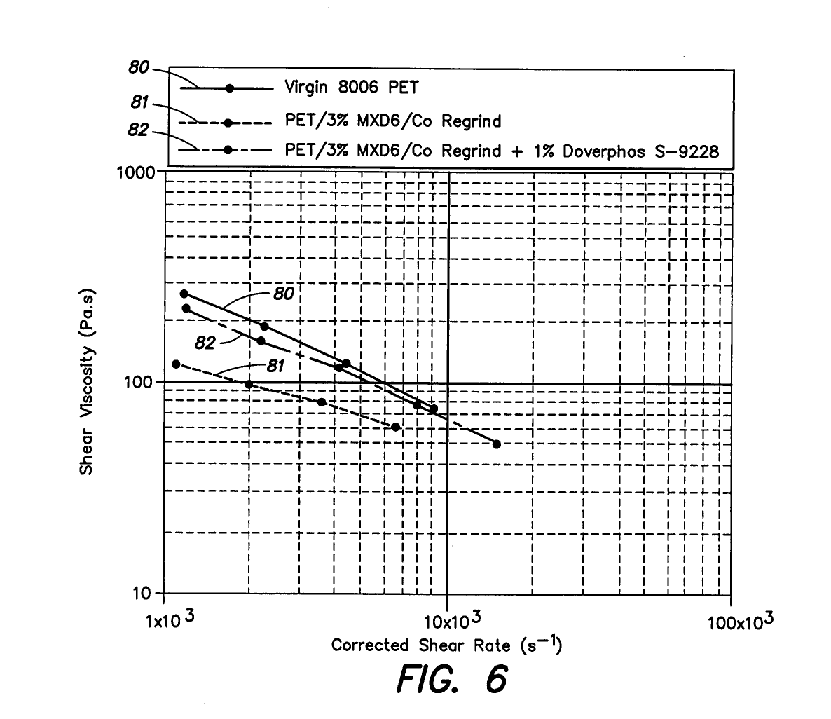

According to another embodiment of the invention, the phosphorous containing mixture (reprocessed mixture) can be provided in one or more layers of a multilayer article having a desired layer integrity and layer adherence for a given application. Layer adherence and integrity is generally a function of the melt viscosity of a polymer material. Melt viscosity can be represented by a melt rheology curve, namely a plot of shear viscosity versus shear rate as shown in FIG. 6 (discussed further below).

Measurement of the melt viscosity of polymers is generally well known in the art and a number of standardized tests are in use, such as those detailed in ASTM D3835 and ISO 11443. In the results presented in FIG. 6, the melt viscosity of the examples was measured at a variety of shear rates spanning the range of about 1,000 sec⁻¹ to about 12,000 sec⁻¹ at a 280° C. melt temperature on a Rosand RH 2000 series capillary melt rheometer, utilizing a 1 mm×16 mm capillary die (Bohlin Instruments, East Brunswick, N.J., USA, www.bohlinusa.com). As is typical practice in the art, the well known Rabinowitsch corrections were applied to the apparent shear rates and the corrected shear rates are utilized on the horizonal-axis in FIG. 6. The following reference can be consulted for further information: Macosko, C. W. “Rheology: Principles, Measurements, and Applications,” VCH Publishers (1994) pp. 242-244.

The polymers as used herein are generally high molecular weight polymers, having a molecular weight of at least 20,000 Daltons, for which the melt viscosity is an important process parameter. Generally, as the molecular weight of the polymer increases, the melt viscosity increases. For multilayer applications, those skilled in the art can determine an appropriate combination of melt viscosity and melt strength for a layer of the reprocessed mixture (phosphorous containing mixture) positioned adjacent to one or more layers of other polymer materials.

Where one or more layers are positioned adjacent a layer of the reprocessed mixture in the absence of an adhesive (e.g., an additive for promoting layer adherence, provided either as a separate layer or within one or more of the adjacent layers), it is preferred that the two layers “be compatible.” Compatibility implies that the multilayer article have the structural integrity to withstand delamination, observable deformation from a desired shape or other degradation of a layer caused by a chemical or other process initiated by an adjacent layer during the article forming process and/or in the final article during respective use. Compatibility can be enhanced by selecting melt viscosities, melt indices, and/or solubility parameters that allow one of ordinary skill in the art to achieve a desired package characteristic.

In accordance with one embodiment, a phosphorous material is added to the previously melt processed polymer materials to avoid an undesired change in melt viscosity during subsequent melt processing. Generally, it is desired to approach (a perfect match is not required) a melt viscosity of an adjacent layer, whereby the reprocessed polymer mixture has sufficient melt strength to spread the reprocessed mixture substantially evenly in a layer of a multilayer article.

FIG. 6 shows the beneficial effect on melt viscosity by the addition of the phosphorous material. FIG. 6 is a graph of shear viscosity (Pa·s) versus corrected shear rate (s⁻¹) for each of the following examples:

a) virgin 8006 PET (80);

b) PET/3% MXD6/Co regrind (one subsequent heat history) without phosphorous added (81); and

c) PET/3% MXD6/Co regrind (same as b) but with 1% Doverphos S-9228 (7.3% P by weight) added as the phosphorous material (82).

The PET/3% MXD6/Co regrind is the same regrind previously described and was subjected to an additional heat history—melt processing in a twin extruder, cooling and pelletizing followed by measurement in the melt rheometer. As shown in FIG. 6, the virgin 8006 PET (80) has the highest shear viscosity. There is a drop in shear viscosity when the previously processed regrind is melt processed without the phosphorous material (81). Adding the phosphorous material (82) improved (increased) the shear viscosity to approach that of the virgin polymer (80). Thus, addition of the phosphorous material can be used to obtain a desired layer compatibility with an adjacent layer in a subsequently melt processed multilayer article.

Preferably, the amount of phosphorous added is sufficient to raise or maintain the shear viscosity value of the reprocessed mixture to a value that is not less than 40% of the shear viscosity value of an adjacent layer polymer material (e.g., virgin PET, which has not been previously melt formed and cooled), when measured at a Rabinowitsch corrected shear rate of 2000 sec⁻¹ and at a melt temperature of 280° C. by capillary melt rheometry (as previously described).

### Enhanced Transparency (Decreased Haze)

In yet another embodiment, it has been found that the addition of the phosphorous material enables reuse of a mixture of previously melt formed and cooled polymer materials with a significant reduction in the amount of haze (opacity) that would otherwise form during the subsequent melt processing.

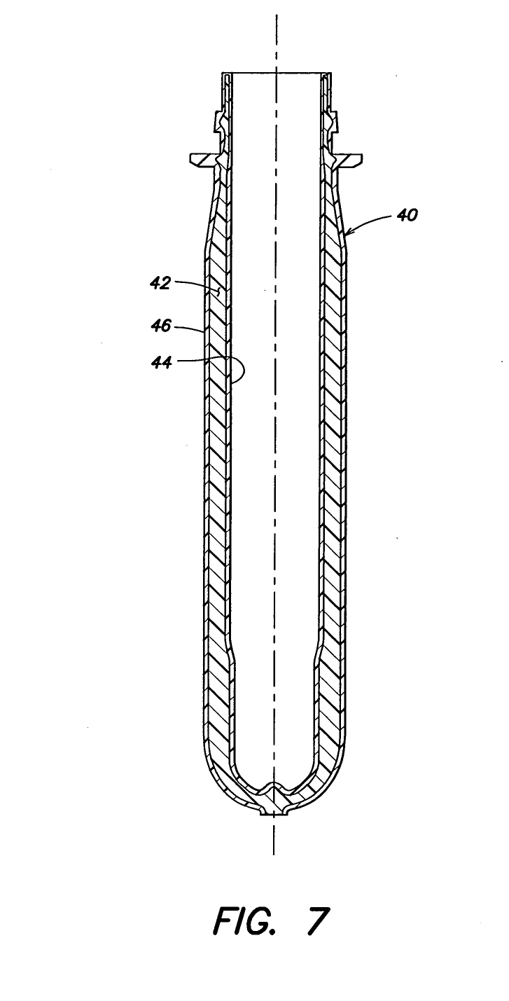

In this embodiment, the invention is directed to eliminating or reducing haze when the regrind is used to form a subsequently melt processed article (e.g., to form injection molded preforms), thus subjecting the regrind polymer material to one or more additional heat histories. The phosphorous material is added in an amount so as to decrease the rate of crystallization of the regrind polymer material, thus enabling the regrind to be formed into a subsequently melt processed article with decreased formation of haze. This is particularly useful with relatively thick articles, which because of their increased thickness have a tendency to cool more slowly and thus are more likely to have a problem with haze formation; also, interior layers in a multilayer article are more likely to have a problem with haze due to slower cooling. By way of example, the reprocessed mixture may be used in a two-material three-layer (2M, 3L) preform 40 (see FIG. 7), where the reprocessed mixture forms a core layer 42 of about 20-60 weight percent of the preform (more specifically 40%), and the exterior inner and outer layers 44 and 46 form the remaining 40-80% of the preform weight.

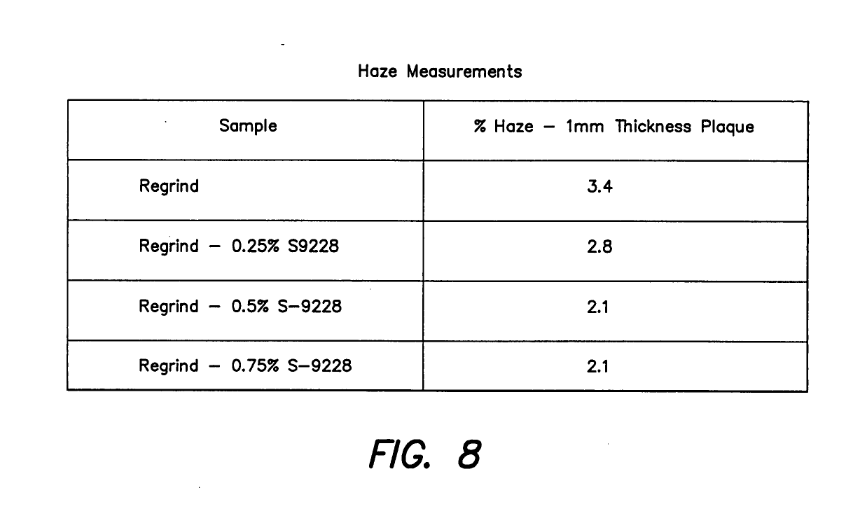

FIG. 8 shows the results of haze measurements as percent haze in a 1 mm thickness plaque, for the following four samples:
a) PET/3% MXD6/Co regrind (same as previously described);
b) same regrind as in a) but with 0.25% Doverphos S-9228 (7.3% P by weight) added as the phosphorous material to the melt during plaque formation;
c) same regrind as b) but with 0.5% S-9228; and
d) same regrind as b) but with 0.75% S-9228.

### The results show decreasing haze with increasing phosphorous content.

These and other modifications would be readily apparent to the skilled person as included within the scope of the following claims.

1. An article formed from a melt mixture, the melt mixture including a reprocessed mixture of polymer materials that have been previously melt formed and cooled, and a phosphorous material present in an amount sufficient to enhance a desired aesthetic and/or functional property of the reprocessed mixture in the article.

2. The article of claim 1, wherein the phosphorous material comprises one or more of a phosphite, a phosphonite and a phosphate.

3. The article of claim 1, wherein the phosphorous material comprises a phosphite material.

4. The article of claim 1, wherein the reprocessed mixture includes a structural polymer and a gas barrier polymer.

5. The article of claim 4, wherein the structural polymer comprises one or more of polyester, polyolefin, polyamide, polyacrylate, poly(lactic acid), polycarbonate, and copolymers and blends thereof.

6. The article of claim 5, wherein the gas barrier polymer comprises one or more of polyalcohol, polyamide, polyglycolic acid, acrylonitrile copolymer, cyclic olefin copolymer, polyvinylidiene chloride, and copolymers and blends thereof.

7. The article of claim 1, wherein the reprocessed mixture includes:
an ester containing polymer and a gas barrier polymer,
the ester containing polymer comprising one or more of polyethylene terephthalate (PET), polyethylene napthalate (PEN), polypropylene terephthalate (PPT), poly(lactic acid) (PLA), polytrimethylene naphthalate (PTN), and copolymers and blends thereof, and
the gas barrier polymer comprising one or more of polyalcohol, polyamide, polyglycolic acid (PGA), acrylonitrile copolymer, cyclic olefin copolymer, polybutadiene/polyester copolymer, polyvinylidiene chloride, and copolymers and blends thereof.

8. The article of claim 1, wherein the article is one or more of:
a package, container, preform, closure, liner, sheet or film;
a multilayer article;
a substantially transparent article; or
a substantially clear article.

9. The article of claim 1, wherein the article is a multilayer article that includes one or more layers of the reprocessed mixture.

10. The article of claim 1, wherein the reprocessed mixture comprises an ester containing polymer and a gas barrier polymer, and the article comprises a multilayer article including at least one layer of the reprocessed mixture and an adjacent layer of an ester containing polymer.

11. The article of claim 10, wherein the ester containing polymer is an aromatic polyester and the gas barrier polymer is a nylon including meta-xylylene groups.

12. The article of claim 1, wherein the reprocessed mixture includes polyethyleneimine (PEI).

13. The article of claim 12, wherein the reprocessed mixture includes polyethylene vinyl alcohol copolymer (EVOH) and PEI.

14. The article of claim 1, wherein the reprocessed mixture comprises regrind.

15. The article of claim 1, wherein the phosphorous material is present in the melt mixture in an amount sufficient to reduce or eliminate coloring of the reprocessed mixture in the article.

16. The article of claim 1, wherein the phosphorous material is present in the melt mixture in an amount sufficient to reduce or eliminate yellowing of the reprocessed mixture in the article.

17. The article of claim 1, wherein the phosphorous material is present in the melt mixture in an amount sufficient to reduce or eliminate haze in the reprocessed mixture in the article.

18. The article of claim 1, wherein the phosphorous material is present in the melt mixture in an amount sufficient to thermally stabilize the reprocessed mixture.

19. The article of claim 1, wherein the article is a multilayer article, the reprocessed mixture includes a structural polymer and a gas barrier polymer, and the reprocessed mixture forms at least one layer of the multilayer article adjacent to another layer of the structural polymer.

20. The article of claim 1, wherein the reprocessed mixture in the article is clear and transparent.

21. The article of claim 1, wherein the elemental phosphorous content of the mixture is in a range of from about 0.01% to about 0.5% by weight of the reprocessed mixture.

22. The article of claim 1, wherein the elemental phosphorous content of the mixture is in a range of from 0.03% to 0.25% by weight of the reprocessed mixture.
